(19) United States
(12) Patent Application Publication
(10) Pub. No.: US 2026/0161115 A1
(43) Pub. Date: Jun. 11, 2026

(54) DEVELOPER CONTAINER AND IMAGE FORMING APPARATUS

(71) Applicant: CANON KABUSHIKI KAISHA, Tokyo (JP)

(72) Inventor: Noritomo Yamaguchi, Kanagawa (JP)

(21) Appl. No.: 19/408,946

(22) Filed: Dec. 4, 2025

(30) Foreign Application Priority Data
Dec. 10, 2024 (JP) 2024-216033

(51) Int. Cl. G03G 15/08

(52) U.S. Cl. CPC G03G 15/0879; G03G 15/0875; G03G 15/0896; G03G 2215/068; G03G 2215/0692

(57) ABSTRACT

A developer container includes: a developer accommodating chamber that accommodates developer and is provided with a discharge port for discharging the accommodated developer to outside of the developer container; a filter that allows passage of air and prevents passage of the developer; and an air chamber partitioned from the developer accommodating chamber by the filter and provided with an air receiving port for receiving air, the air chamber being aligned with the developer accommodating chamber in a first direction, wherein the discharge port and the air receiving port are both provided on an end surface of the developer container in a direction from the air chamber toward the developer accommodating chamber in the first direction.

### BACKGROUND

### Field of the Technology

The present disclosure relates to an image forming apparatus that replenishes developer from a developer container that is attachable to and detachable from the image forming apparatus.

### Description of the Related Art

In image forming apparatuses such as printers and copiers, a developer such as fine-powder toner is used, and each time the toner that is consumed during image formation runs out, toner is replenished from a toner replenishment container (developer replenishment container) to a developing portion. As such an image forming apparatus, for example, a configuration has been proposed in which air is supplied by an air pump to a toner replenishment container storing a large amount of toner, and in which the toner in the toner replenishment container is suctioned by a suction pump, and moreover in which the toner is fed to the developing portion of the image forming apparatus (e.g., Japanese Patent Application Laid-Open No. 2007-249151).

However, in the above prior art, if the suctioned toner were, for example, to cause a clog in the conveyance passage and thereby block the toner conveyance passage, and air supply from the air pump were to continue in that state, there would be a concern that the toner supply container would experience an increase in internal pressure. If the user removes the toner supply container from the main body of the image forming apparatus while the internal pressure of the toner supply container remains elevated, there is a concern that, when the connection to the toner supply portion is disengaged, toner will spurt forcefully from the toner supply container and soil the apparatus and the like.

### SUMMARY

The present disclosure is directed to provide a technology capable of suppressing contamination caused by the developer when detaching the developer container from the apparatus main body.

In order to solve the above problem, the present disclosure provides a developer container including:
a developer accommodating chamber that accommodates developer and is provided with a discharge port for discharging the accommodated developer to outside of the developer container;
a filter that allows passage of air and prevents passage of the developer; and
an air chamber partitioned from the developer accommodating chamber by the filter and provided with an air receiving port for receiving air, the air chamber being aligned with the developer accommodating chamber in a first direction,
wherein the discharge port and the air receiving port are both provided on an end surface of the developer container in a direction from the air chamber toward the developer accommodating chamber in the first direction.

In order to solve the above problem, the present disclosure provides an image forming apparatus for forming an image on a recording material, the apparatus including:
an apparatus main body having a main body accommodating portion that accommodates developer and a mounting portion; and
a developer container mounted, by being moved in an attachment direction, to the mounting portion, the developer container being configured to be detached by being moved in a detachment direction opposite to the attachment direction,
wherein the developer container comprises:
   a developer accommodating chamber that accommodates developer and is provided with a discharge port for discharging the accommodated developer to outside of the developer container;
   a filter that allows passage of air and prevents passage of the developer; and
   an air chamber partitioned from the developer accommodating chamber by the filter and provided with an air receiving port for receiving air, the air chamber being aligned with the developer accommodating chamber in a first direction,
wherein the apparatus main body comprises:
   a developer conveyance passage configured such that one end portion communicates with inside of the main body accommodating portion and another end portion is provided with a developer receiving port, the developer conveyance passage being configured such that the developer receiving port communicates with the discharge port of the developer container mounted at a predetermined position of the mounting portion;
   an air supply passage provided with an air supply port, the air supply passage being configured to communicate with the air receiving port of the developer container mounted at the predetermined position of the mounting portion; and
   an air supply portion that supplies air to the air chamber from the air receiving port of the developer container via the air supply passage, and
wherein the discharge port and the air receiving port are both provided on an end surface of the developer container in a direction from the air chamber toward the developer accommodating chamber in the first direction.

Further features of the present disclosure will become apparent from the following description of embodiments with reference to the attached drawings. The following description of embodiments is described by way of example.

### BRIEF DESCRIPTION OF THE DRAWINGS

FIG. 1 is a cross-sectional view of an image forming apparatus according to the first embodiment of the present disclosure.

FIG. 2 is an explanatory view of cartridge replacement in the image forming apparatus according to the first embodiment of the present disclosure.

FIG. 3A is a view illustrating a state in which a toner container according to the first embodiment of the present disclosure is housed in a predetermined mounting position of an accommodating (mounting portion) of the apparatus main body of the image forming apparatus, and toner is conveyed by air from the toner container to a toner accommodating portion of a developing device.

FIG. 3B is a view illustrating a process of removing the toner container from the apparatus main body of the image forming apparatus for replacement or the like.

FIG. 3C is a view showing a state in which the toner container is further moved from the position shown in FIG. 3B.

FIG. 4A is an enlarged view showing details of portion B in FIG. 3A.

FIG. 4B is an enlarged view showing details of portion B in FIG. 3B.

FIG. 5 is a view of the toner container according to the first embodiment of the present disclosure as seen from the back side in the attachment direction.

FIG. 6A is a cross-sectional view showing a state in which a toner container according to the second embodiment of the present disclosure is housed in an accommodating portion (mounting portion) of the apparatus main body.

FIG. 6B is a view illustrating a state in the process of removing the toner container from the apparatus main body from the state of FIG. 6A, showing a cross-sectional view of a state in which a toner container replacement door is opened.

FIG. 6C is a view illustrating a state in the process of removing the toner container from the apparatus main body from the state of FIG. 6A, showing a cross-sectional view of a state in which the toner container is pulled out in the direction of the arrow.

FIG. 7 is a cross-sectional view of an image forming apparatus according to the third embodiment of the present disclosure.

FIG. 8A is an explanatory view of an operation mechanism of an air release valve of the image forming apparatus according to the third embodiment of the present disclosure, showing a state in which a toner container replacement door is closed.

FIG. 8B is an explanatory view of the operation mechanism of the air release valve of the image forming apparatus according to the third embodiment of the present disclosure, showing a state in which the toner container replacement door is opened.

FIG. 9A is an explanatory view of the operation mechanism of the air release valve of the image forming apparatus according to the third embodiment of the present disclosure, showing a state in which the toner container replacement door is closed and the air release valve is in a sealed state (closed valve).

FIG. 9B is an explanatory view of the operation mechanism of the air release valve of the image forming apparatus according to the third embodiment of the present disclosure, showing a state in which the toner container replacement door is opened and the air release valve is in an unsealed state (open valve).

FIG. 10A is a cross-sectional view similar to the A-arrow view cross-section of the apparatus main body according to the fourth embodiment of the present disclosure, showing a mechanism for air release with the toner container replacement door closed.

FIG. 10B is a cross-sectional view similar to the A-arrow view cross-section of the apparatus main body according to the fourth embodiment of the present disclosure, showing a mechanism for air release with the toner container replacement door opened.

FIG. 11 is a block diagram showing a control configuration of a toner supply portion according to the fifth embodiment of the present disclosure.

FIG. 12 is a flowchart showing control of the image forming apparatus according to the fifth embodiment of the present disclosure.

FIG. 13 is a flowchart showing toner container removal control according to the fifth embodiment of the present disclosure.

FIG. 14A is a perspective view of a toner container according to the sixth embodiment of the present disclosure.

FIG. 14B is a cross-sectional view of the toner container according to the sixth embodiment of the present disclosure.

FIG. 15A is a cross-sectional view of a toner container without a label attached according to the sixth embodiment of the present disclosure, being a cross-sectional view taken along the E-arrow in FIG. 15C.

FIG. 15B is a cross-sectional view of a toner container without a label attached according to the sixth embodiment of the present disclosure, being a cross-sectional view taken along the F-arrow in FIG. 15C.

FIG. 15C is a front view of a toner container without a label attached according to the sixth embodiment of the present disclosure, being a view taken along the H-arrow in FIG. 15A.

FIG. 15D is a bottom view of a toner container without a label attached according to the sixth embodiment of the present disclosure, being a view taken along the G-arrow in FIG. 15C.

FIG. 16A is an exploded view of a toner container according to the sixth embodiment of the present disclosure, being an exploded perspective view shown at an angle looking diagonally downward from above the toner container.

FIG. 16B is an exploded view of a toner container according to the sixth embodiment of the present disclosure, being an exploded perspective view shown at an angle looking diagonally upward from below the toner container.

FIG. 17A is a view showing a state in which a toner container is mounted to a mounting portion of an image forming apparatus according to the sixth embodiment of the present disclosure.

FIG. 17B is a view showing a mounting portion of an image forming apparatus according to the sixth embodiment of the present disclosure with the toner container removed.

FIG. 18A is an explanatory view of a process of detaching a toner container from a mounting portion according to the sixth embodiment of the present disclosure, showing a state in which the toner container is mounted to the mounting portion of the apparatus main body.

FIG. 18B is an explanatory view of a process of detaching a toner container from a mounting portion according to the sixth embodiment of the present disclosure, showing a state in which a lever portion as an operated portion is pressed down, and the engagement between the toner container and the mounting portion is released.

FIG. 18C is an explanatory view of a process of detaching a toner container from a mounting portion according to the sixth embodiment of the present disclosure, showing a state in which the toner container starts to be detached from a predetermined position of the mounting portion, and a shutter starts moving from an open position to a closed position.

FIG. 18D is an explanatory view of a process of detaching a toner container from a mounting portion according to the sixth embodiment of the present disclosure, showing a state in which the toner container is detached from a predetermined position of the mounting portion, and the shutter has completed moving to the closed position.

### DESCRIPTION OF THE EMBODIMENTS

Embodiments of the present disclosure will be exemplarily described in detail, on the basis of examples, with reference to the drawings. However, the dimensions, materials, shapes, relative arrangements, and the like of the components described in the embodiments may be appropriately modified in accordance with the configurations and various conditions of apparatuses to which the present disclosure is applied. In other words, the scope of the present disclosure is not intended to be limited to the embodiments described below. While a plurality of features is described in each of the embodiments, all of the plurality of features are not necessarily essential to the present disclosure and the plurality of features may be combined with each other in any way. Moreover, in the accompanying drawings, the same reference numerals are assigned to the same or similar components, and redundant descriptions thereof are omitted.

### First Embodiment

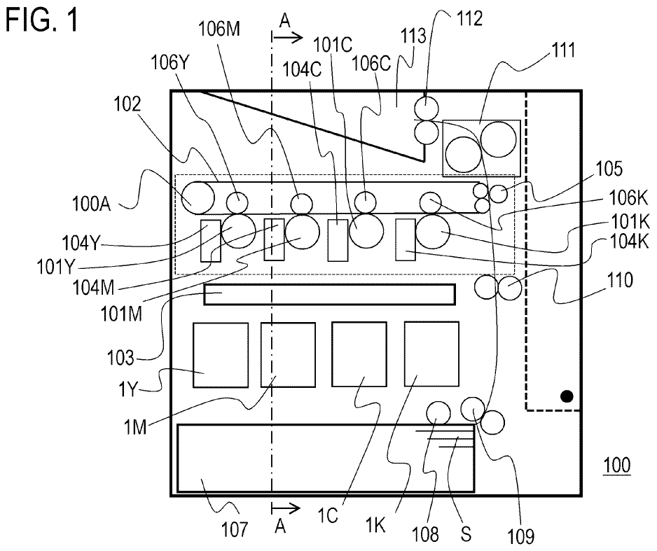

FIG. 1 is a schematic cross-sectional view illustrating a configuration of a color laser printer, which is an example of an image forming apparatus according to a first embodiment of the present disclosure. The image forming apparatus includes an image forming apparatus main body (hereinafter, referred to as an apparatus main body) 100, and an image forming portion 100A that is provided in the apparatus main body 100 and performs image formation by an electrophotographic system. The image forming portion 100A includes photosensitive drums (image bearing members) 101, an intermediate transfer belt 102, developing devices 104, primary transfer rollers 106, and a secondary transfer roller 105.

The photosensitive drums 101 include four photosensitive drums (image bearing members) 101Y, 101M, 101C, and 101K that form toner images (developer images) of four colors of yellow, magenta, cyan, and black. The intermediate transfer belt 102 is an endless belt-shaped member which comes into contact with the four photosensitive drums 101Y to 101K and to which the toner images formed on the four photosensitive drums 101Y to 101K are primarily transferred. The primary transfer rollers 106 include primary transfer rollers 106Y, 106M, 106C, and 106K corresponding to the toners of four colors. The primary transfer rollers 106Y to 106K are disposed at positions corresponding to the photosensitive drums 101Y to 101K on an inner peripheral side of the intermediate transfer belt 102. The primary transfer rollers 106Y to 106K sandwich the intermediate transfer belt 102 with the photosensitive drums 101Y to 101K such that nips are formed between the photosensitive drums 101Y to 101K and an outer peripheral side of the intermediate transfer belt 102. When a primary transfer bias is applied from a power supply (not illustrated), the primary transfer rollers 106Y to 106K generate potential differences between the photosensitive drums 101Y, 101M, 101C, and 101K and the intermediate transfer belt 102, and the toner images borne on the photosensitive drums 101Y to 101K at the above-described nips are sequentially primarily transferred to the outer peripheral side of the intermediate transfer belt 102 in a superimposed manner. The secondary transfer roller 105 forms a nip with the outer peripheral side of the intermediate transfer belt 102, and secondarily transfers the images transferred from the photosensitive drums 101Y to 101K to the intermediate transfer belt 102 to a sheet (recording material) S when a secondary transfer bias is applied from the power supply (not illustrated).

When an image forming operation is started in the image forming portion 100A, the photosensitive drums 101Y to 101K are irradiated with light corresponding to an image signal by a laser scanner 103, and latent images are formed on the photosensitive drums 101Y to 101K. Each of developing devices 104Y, 104M, 104C, and 104 includes a developing roller (developer bearing member), a developing blade (developer restricting member), a toner accommodating portion (developer accommodating portion or main body accommodating portion), and the like. In FIG. 1, only the toner accommodating portions of the configurations of the developing devices 104Y to 104K are illustrated. The developing devices 104Y to 104K develop the latent images on the photosensitive drums 101Y to 101K by using the toners stored in the toner accommodating portions, and form the toner images (visible images) on the photosensitive drums 101Y to 101K. The toner images formed on the photosensitive drums 101Y to 101K are then primarily transferred to the intermediate transfer belt 102. The toner images borne on the intermediate transfer belt 102 are conveyed to a secondary transfer portion by the rotation of the intermediate transfer belt 102. In the developing devices 104Y to 104K, when the toner accommodated in the toner accommodating portion is consumed, the toners are sequentially pumped up from toner cartridges 1Y, 1M, 1C, and 1K serving as developer containers and replenished.

In parallel with the image forming operation, a plurality of sheets S accommodated in the sheet storage portion 107 are fed one by one by a pickup roller 108. Then, the sheet S is conveyed to the secondary transfer portion formed by the nip between the intermediate transfer belt 102 and the secondary transfer roller 105, by a feed roller 109 and a registration roller 110 that performs skew correction of the sheet S. Here, since it is necessary to align a position of the sheet S in a sheet conveying direction with respect to the toner images formed on the intermediate transfer belt 102, a timing for conveying the sheet S to the secondary transfer portion is adjusted by conveying speed control of the registration roller 110 and the feed roller 109. In the secondary transfer portion, the toner images are transferred from the intermediate transfer belt 102 to the sheet S by applying a high-voltage current to the secondary transfer roller 105. Thereafter, the sheet S to which the toner images have been transferred is conveyed to fixing unit 111, and the toner images are fixed to the sheet S by being heated and pressurized in the fixing unit 111. After the fixing, the sheet S is discharged to a discharge portion 113 at an upper portion of the apparatus by a discharge roller 112.

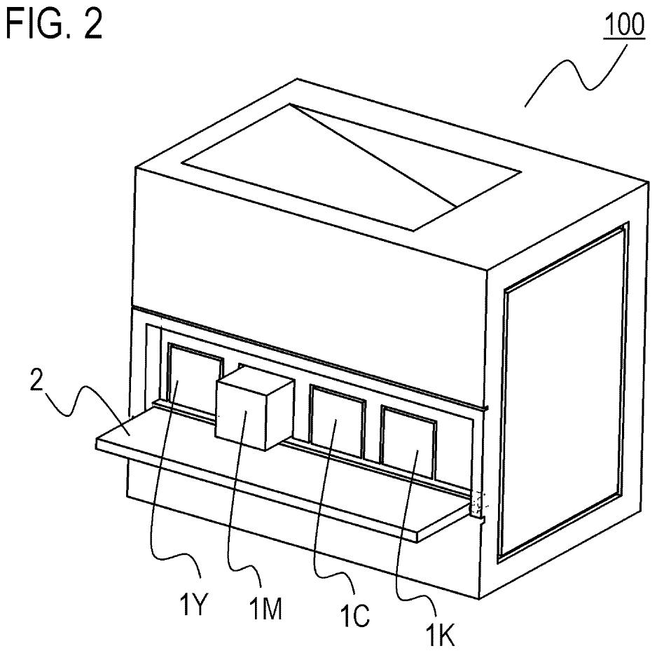

FIG. 2 is a view illustrating a state in which a toner container replacement door 2 is opened to replace a toner cartridge (hereinafter, referred to as a toner container) 1 detachably attached to the apparatus main body 100. Four toner containers 1 are arranged in the order of a toner container 1Y for accommodating a yellow toner, a toner container 1M for accommodating a magenta toner, a toner container 1C for accommodating a cyan toner, and a toner container 1K for accommodating a black toner. Each of the toner containers 1Y to 1K is mounted on an accommodating portion in the apparatus main body 100. FIG. 2 illustrates a state in which the toner container 1M is replaced as an example, and the toner container 1M is replaced by being pulled out from an apparatus back surface side toward an apparatus front surface side through an opening portion provided in a front surface of the apparatus main body 100 of the image forming apparatus.

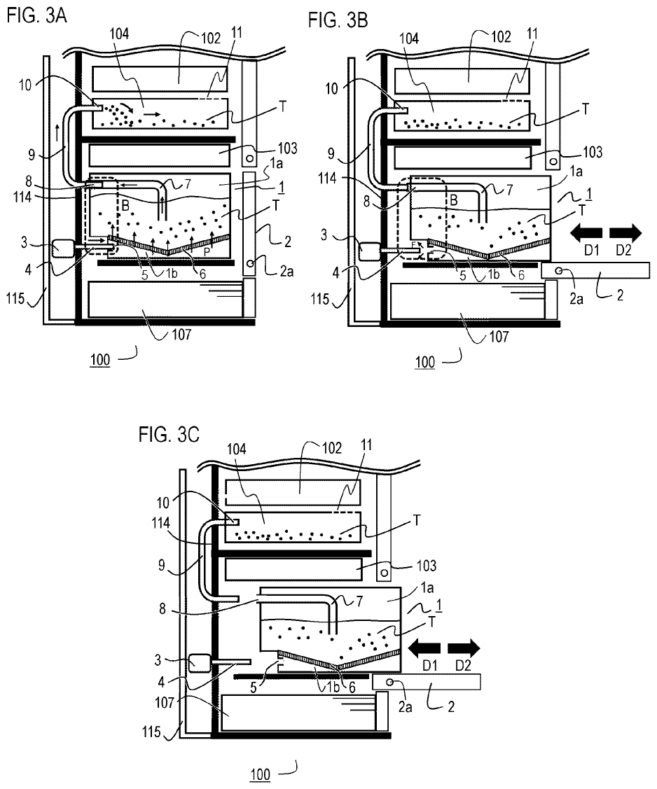

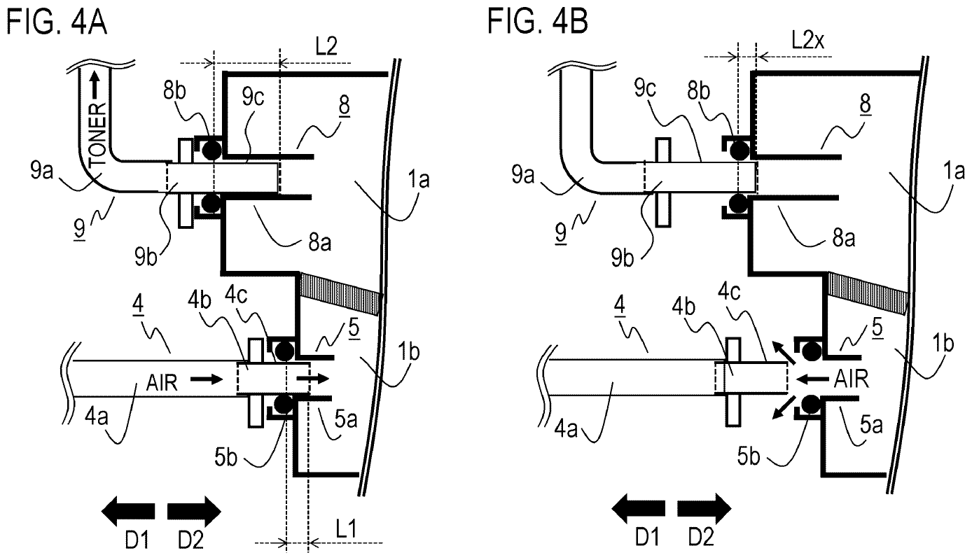

FIG. 3A, FIG. 3B, and FIG. 3C are cross-sectional views taken along the A-arrow in the apparatus main body 100 in FIG. 1. FIG. 3A is a view illustrating a state in which the toner container 1M is housed in a predetermined mounting position of an accommodating portion (mounting portion) of the apparatus main body 100 of the image forming apparatus, and toner T is conveyed by air from the toner container 1 to a toner accommodating portion of the developing device 104. FIG. 3B and FIG. 3C are views illustrating states in the process of removing the toner container 1 from the apparatus main body 100. FIG. 4A and FIG. 4B are enlarged views showing details of portion B in FIG. 3A and FIG. 3B, respectively.

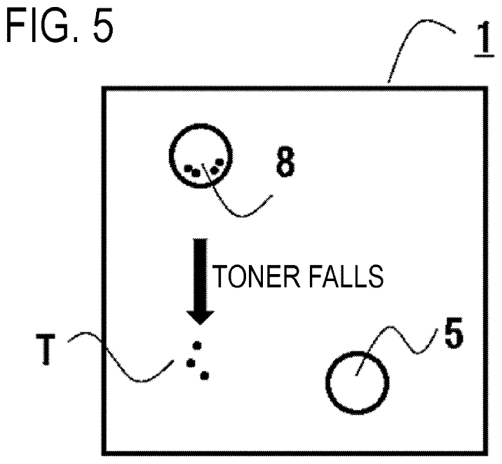

In FIG. 3A, FIG. 3B, and FIG. 3C, as in FIG. 1, only the toner accommodating portion among the components of the developing device 104 is shown. Additionally, the developing device 104 and toner container 1 shown in FIG. 3A to FIG. 3C are the developing device 104M and toner container 1M for magenta toner, but the developing devices 104Y, 104C, and 104K and toner containers 1Y, 1C, and 1K for other colors are similarly configured. In the configurations shown in FIG. 3A to FIG. 3C and the descriptions related to FIG. 3A to FIG. 3C, the suffixes Y, M, C, and K added to the end of each reference numeral to distinguish toner colors are omitted as appropriate unless distinction of colors is necessary. The same applies to FIG. 4A to FIG. 5. That is, Y, M, C, and K are also omitted for each configuration of the developing device 104, a pump 3, an air conveyance passage 4, a toner discharge passage 7, and the like provided for each toner container 1 described below.

The toner container 1 is configured to be mountable to the apparatus main body 100 by being moved in an attachment direction (D1 direction) when the toner container replacement door 2 is opened, and detachable by being moved in a detachment direction (D2 direction) opposite to the attachment direction. In this embodiment, the attachment direction (D1 direction) and the detachment direction (D2 direction) are directions parallel to the installation surface (horizontal plane) of the image forming apparatus.

The pump 3 shown in FIG. 3A is an air pump that supplies air to the toner container 1 through an air conveyance passage 4 from an air supply portion 5 of the toner container 1. The pump 3 is disposed outside a frame 114 of the apparatus main body 100 that forms a space (mounting portion) for accommodating the toner container 1, and is arranged such that, even in the event of a failure requiring replacement, the exterior 115 can be removed to access and replace it from the back side of the apparatus.

The filter floor 6 provided in the toner container 1 is a filter for separating (partitioning) a toner accommodating chamber (developer accommodating chamber) 1a and an air chamber 1b within the toner container 1. In this embodiment, the toner accommodating chamber 1a and the air chamber 1b are vertically partitioned by the filter floor 6 (such that the air chamber 1b is below the toner accommodating chamber 1a). The filter floor 6 is a filter with a mesh fineness sufficiently smaller than the particle size of toner T, preventing the passage of toner T and allowing only air to pass through (permitting passage).

Air is supplied to the toner container 1 through the air supply portion 5 by the pump 3 in the direction of the arrow. When the air is supplied to the toner container 1, an internal pressure of the entire toner container 1 including the toner accommodating chamber 1a is increased by the air passing through the filter floor 6 from the air chamber 1b. Due to the increased air pressure, the toner T in the toner accommodating chamber 1a is conveyed outside the toner container 1 through the toner discharge passage 7 from the toner discharge portion 8. The toner T discharged from the toner discharge portion 8 is conveyed to the toner accommodating portion of the developing device 104 with the airflow through the toner conveyance passage 9 provided in the apparatus main body 100.

The toner T conveyed through the toner conveyance passage 9 is supplied to the toner accommodating portion of the developing device 104 from the inner side in the attachment/detachment directions of the developing device 104, and is fed by the air pressure in a longitudinal direction of the toner accommodating portion. A degassing portion 11 is a filter provided on a top surface or near the top surface of the toner accommodating portion of the developing device 104 to remove the air in the toner accommodating portion, and has air permeability necessary for appropriately conveying the toner T in the toner accommodating portion.

FIG. 4A is a detailed view illustrating the respective connection structures of the air supply portion 5 and the toner discharge portion 8. The air conveyance passage 4 includes an air conveyance tube 4a and an air supply connection port 4b. The air conveyance passage 4 is an air supply passage that can communicate with the inside of the toner container 1 by being connected to the air supply portion 5. The air supply connection port (air feeding port) 4b is opened in a direction (a direction of arrow D2) opposite to an attachment direction (a direction of arrow D1) of the toner container 1 with respect to the mounting portion of the apparatus main body 100. The air conveyance tube 4a is a tube that feeds the air from the pump 3 to the toner container 1. The air supply portion 5 includes an air supply port 5 a and an O-ring 5b. The air supply port (air receiving port) 5a is a connection portion to which the air supply connection port (air feeding port) 4b is connected, and is opened in the attachment direction (first direction) (the direction of arrow D1) of the toner container 1 with respect to the mounting portion of the apparatus main body 100. The O-ring 5b is an annular sealing member that is in close contact with an outer periphery of the air supply connection port 4b to prevent the air from leaking to the outside of the toner container 1. In a state in which the toner container 1 is mounted in the apparatus main body 100, a tip of the air supply connection port 4b is inserted into the air chamber 1b by a connection distance L1 from a position (for example, a wire diameter center of the O-ring 5b) of the O-ring 5b in an insertion direction with respect to the air supply port 5 a.

The toner conveyance passage 9 includes a toner conveyance tube 9a and a toner conveyance connection port 9b. The toner conveyance passage 9 is a developer conveyance passage that can communicate between the interior of the toner container 1 and the interior of the toner accommodating portion of the developing device 104 by having one end portion communicating with the interior of the toner accommodating portion of the developing device 104 and the other end portion connected to the toner discharge portion 8. The toner conveyance connection port (developer receiving port) 9b opens in a direction (arrow D2 direction) opposite to the attachment direction (arrow D1 direction) of the toner container 1 with respect to the mounting portion of the apparatus main body 100. The toner conveyance tube 9a is a tube that guides toner sent by air pressure. The toner conveyance tube 9a is arranged in a passage that avoids interference with other units in the apparatus main body 100, such as the laser scanner 103, or functional parts such as the laser optical path, interposed between the toner container 1 and the toner accommodating portion of the developing device 104. The toner discharge portion 8 includes a toner conveyance port (developer discharge port) 8a and an O-ring 8b. The toner conveyance port (developer discharge port) 8a is a connection portion to which the toner conveyance connection port 9b is connected, and opens in the attachment direction (arrow D1 direction) of the toner container 1 with respect to the mounting portion of the apparatus main body 100. The O-ring 8b is an annular sealing member (seal member) that prevents toner leakage to the outside of the toner container 1 by closely contacting the outer periphery of the toner conveyance connection port 9b. When the toner container 1 is mounted in the apparatus main body 100, the toner conveyance connection port 9b is inserted into the toner accommodating chamber 1a by a connection distance L2 from the position of the O-ring 8b (e.g., the wire diameter center of the O-ring 8b) in the insertion direction with respect to the toner conveyance port 8a.

By sealing outer peripheral portions of the air supply connection port 4b and the toner conveyance connection port 9b with the O-ring 5b and the O-ring 8b in this manner, reliable sealing can be performed even in a case where positioning of the toner container 1 in the attachment/detachment directions with respect to the apparatus main body 100 is rough. Here, a relationship between connection distances, which are insertion amounts in the connection of the air supply portion 5 and the toner discharge portion 8, is set such that ‘L1<L2’ as illustrated in FIG. 4A. That is, when the toner container 1 is moved in a detachment direction (the direction of arrow D2) from a predetermined mounting position in the mounting portion, a timing (second timing) at which the O-ring 8b serving as a second sealing member no longer remains in close contact with the outer periphery of the toner conveyance connection port 9b is later than a timing (first timing) at which the O-ring 5b serving as a first sealing member no longer remains in close contact with the outer periphery of the air supply connection port 4b.

FIG. 3B is a view illustrating a process of removing the toner container 1 from the apparatus main body 100 of the image forming apparatus for replacement or the like. The toner container replacement door 2 is an opening/closing door (opening/closing member) held rotatably around a door hinge 2a. By opening the toner container replacement door 2, an opening portion of the toner container accommodating portion in the apparatus main body 100 is opened to the outside of the apparatus main body 100, enabling replacement of the toner container 1. The toner container 1 is supported on the upper surface of the toner container replacement door 2 in an open state (open position) and can be removed (detached) from the apparatus main body 100 by moving in the arrow D2 direction and mounted (attached) to the apparatus main body 100 by moving in the arrow D1 direction.

As shown in FIG. 4A, the connection between the air conveyance passage 4 and the air supply portion 5 and the connection between the toner discharge portion 8 and the toner conveyance passage 9 have a relationship of L1<L2.

The outer peripheral surface of the air supply connection port 4b of the air conveyance passage 4 constitutes a region extending in the attachment direction (D1 direction) of the toner container 1 with respect to the apparatus main body 100 in the air conveyance passage 4. The outer peripheral surface of the air supply connection port 4b includes a sliding region 4c (first sliding region) that allows the O-ring 5b to slide in the attachment direction while maintaining close contact when the toner container 1 is moved in the attachment direction toward a predetermined position of the mounting portion of the apparatus main body 100. Similarly, the outer peripheral surface of the toner conveyance connection port 9b of the toner conveyance passage 9 constitutes a region extending in the attachment direction (D1 direction) in the toner conveyance passage 9. The outer peripheral surface of the toner conveyance connection port 9b includes a sliding region 9c (second sliding region) that allows the O-ring 8b to slide in the attachment direction while maintaining close contact when the toner container 1 is moved in the attachment direction toward a predetermined position of the mounting portion of the apparatus main body 100. The positional relationship of the O-ring 5b, the sliding region 4c, the O-ring 8b, and the sliding region 9c in the attachment direction (D1 direction) is such that, when mounting the toner container 1 to the apparatus main body 100, the O-ring 5b comes into close contact with the sliding region 4c after the O-ring 8b comes into close contact with the sliding region 9c. In other words, the O-ring 8b comes into close contact with the sliding region 9c before the O-ring 5b comes into close contact with the sliding region 4c. To form such a mounting configuration, the length L1 of the sliding region 4c in the attachment direction (D1 direction) is shorter than the length L2 of the sliding region 9c in the attachment direction (D1 direction).

Therefore, when moving the toner container 1 in the detachment direction (D2 direction) from the mounting portion of the apparatus main body 100, the first timing at which the O-ring 5b ceases to closely contact the outer periphery of the air conveyance passage 4 occurs before the second timing at which the O-ring 8b ceases to closely contact the outer periphery of the toner conveyance passage 9. As shown in FIG. 4B, when the toner container 1 is moved in the detachment direction (D2 direction) from the apparatus main body 100, the connection of the air supply portion 5 to the air conveyance passage 4 is first released, while the connection of the toner discharge portion 8 to the toner conveyance passage 9 remains connected by a connection distance L2x. At this time, the air in the air chamber 1b escapes in the direction of the arrow, and the internal pressure in the toner container 1 becomes equivalent to the ambient atmospheric pressure. When the toner container 1 is further moved from the position shown in FIG. 3B, the state shown in FIG. 3C is reached, and the connection of the toner discharge portion 8 to the toner conveyance passage 9 is also released. That is, when the toner container 1 is detached from the apparatus main body 100, the connection between the toner conveyance port 8a of the toner container 1 and the toner conveyance connection port 9b of the apparatus main body 100 is released after the connection between the air supply port 5a of the toner container 1 and the air supply connection port 4b of the apparatus main body 100 is released.

By releasing the connection of the air supply portion 5 prior to the toner discharge portion 8 to make the pressure inside the toner container 1 equivalent to the ambient atmospheric pressure around the toner container 1 and then releasing the connection of the toner discharge portion 8, it is possible to prevent the toner T from blowing out from the toner discharge portion 8. The method of removing the toner container 1 includes various means, such as a configuration in which the user pulls the toner container 1 by holding a gripping portion or a configuration in which the toner container 1 is automatically discharged by an ejection mechanism provided in the apparatus main body 100. The toner container removal method in this embodiment is not limited to a specific method.

FIG. 5 is a schematic view of the toner container 1 as seen from the back side in the attachment direction. The air supply portion 5 and the toner discharge portion 8 are both provided on the inner side in the attachment/detachment direction of the toner container 1 with respect to the apparatus main body 100. The air supply portion 5 and the toner discharge portion 8 are arranged to be within the projected area of the toner container 1 when the toner container 1 is viewed in the attachment/detachment direction. This allows effective use of the space inside the apparatus main body 100, enabling miniaturization of the apparatus.

Additionally, the toner conveyance port 8a of the toner discharge portion 8 is arranged above the air supply port 5a of the air supply portion 5 in the gravity direction and is positioned at a different location from the air supply port 5a in a direction perpendicular to the gravity direction (horizontal direction). That is, the toner conveyance port 8a and the air supply port 5a are provided on the end surface of the toner container 1 in the attachment direction (D1 direction) and are arranged such that their positions in the horizontal direction intersecting the attachment direction (D1 direction) differ when viewed in the detachment direction (D2 direction). By avoiding the air supply port 5a being directly below the toner conveyance port 8a, even if toner T adhering around the toner conveyance port 8a falls during attachment or detachment of the toner container 1 from the apparatus main body 100, it is suppressed from falling onto the air supply port 5a.

Furthermore, in this embodiment, as shown in FIG. 4A, FIG. 4B, and the like, the toner conveyance port 8a and the air supply port 5a are arranged at different positions in the attachment/detachment direction. This suppresses the toner T falling from around the toner conveyance port 8a from adhering to the vicinity of the air supply port 5a.

### Second Embodiment

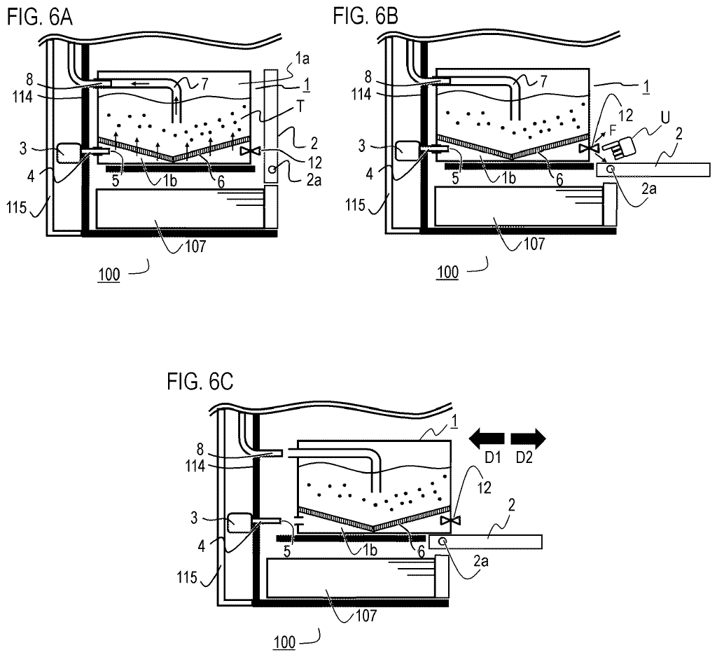

An image forming apparatus according to the second embodiment of the present disclosure will be described with reference to FIG. 6A to FIG. 6C. In the second embodiment, a basic configuration of the apparatus main body 100, the toner container 1, and the outline of a configuration in which toner T is conveyed from the toner container 1 to a toner accommodating portion of a developing device 104 by supplying air to the toner container 1 using a pump 3 are the same as those in the first embodiment. Here, a configuration different from that of the first embodiment in the second embodiment will be mainly described. Matters not specifically described herein in the second embodiment are the same as those in the first embodiment.

FIG. 6A, FIG. 6B, and FIG. 6C are cross-sectional views taken along the A-arrow in the apparatus main body 100 in FIG. 1. FIG. 6B and FIG. 6C are views illustrating states in the process of removing the toner container 1 from the apparatus main body 100 from the state in which the toner container 1 is housed in the accommodating portion (mounting portion) of the apparatus main body 100 (FIG. 6A).

In this embodiment, the toner container 1 is provided with an air release valve 12 as an air vent valve that can communicate between the air chamber 1b of the toner container 1 and the outside of the toner container 1. The air release valve 12 is provided on the end surface of the toner container 1 in the detachment direction (D2) and is configured to be operable by user operation.

The air release valve 12 is a valve that can manually control the opening or closing of an air flow passage connecting the air chamber 1b of the toner container 1 to the outside of the toner container 1. The air release valve 12 is provided on the front side in the attachment/detachment direction of the toner container 1 and, as shown in FIG. 6B, is arranged at a position accessible to a user U when the toner container replacement door 2 is opened. By operating the air release valve 12 before replacing the toner container 1, the user U can make the internal pressure of the toner container 1 equivalent to the ambient atmospheric pressure. FIG. 6C is a view illustrating a state in which the toner container 1 is pulled out in the direction of the arrow, and when the toner container 1 is pulled out, the connection of the toner discharge portion 8 is released. By operating the air release valve 12 to release air from the toner container 1 and then releasing the connection of the toner discharge portion 8, it is possible to prevent the toner T from blowing out from the toner discharge portion 8.

### Third Embodiment

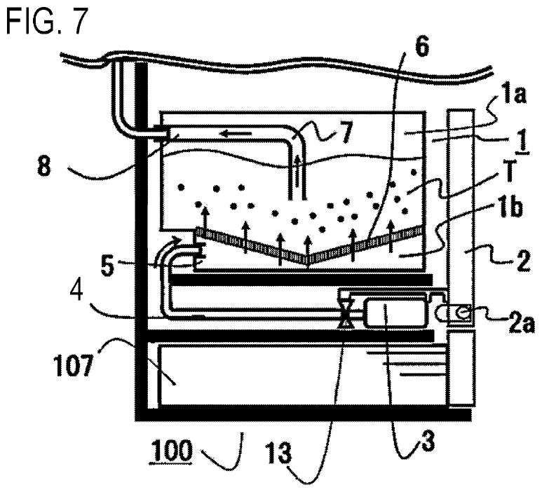

Referring to FIG. 7 to FIG. 9A and FIG. 9B, an image forming apparatus according to the third embodiment of the present disclosure will be described. In the third embodiment, a basic configuration of an apparatus main body 100, a toner container 1, and an outline of a configuration in which a toner T is conveyed from the toner container 1 to a toner accommodating portion of a developing device 104 by supplying air to the toner container 1 using a pump 3 are the same as those in the first embodiment. Here, a configuration different from those of the first and second embodiments in the third embodiment will be mainly described. Matters not specifically described herein in the third embodiment are the same as those in the first and second embodiments.

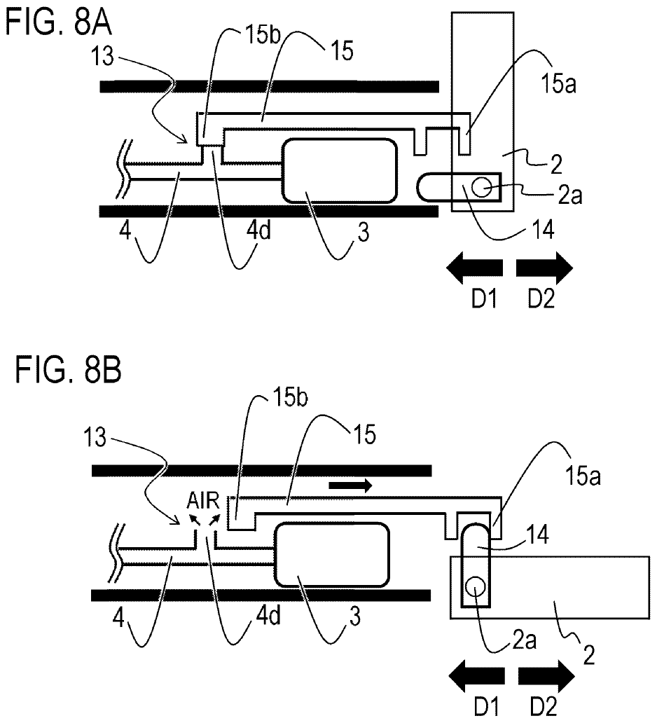

FIG. 7 is a cross-sectional view similar to the A-arrow view cross-section of the apparatus main body 100 in FIG. 1. The air release valve 13 is a valve provided in the air conveyance passage 4 that can control the opening or closing of an air flow passage. FIG. 8A and FIG. 8B are partial enlarged views showing the mechanism for operating the air release valve 13, with FIG. 8A showing a state in which the toner container replacement door 2 is closed, and FIG. 8B showing a state in which the toner container replacement door 2 is opened. The air release valve 13 described in this embodiment is configured to open and close the flow passage in conjunction with the opening/closing operation of the toner container replacement door 2, and the details will be described below.

The image forming apparatus according to this embodiment is provided with an air release valve 13 in the air conveyance passage 4. The air release valve 13 includes an opening portion 4d provided in the air conveyance passage 4 between the connection portion with the pump 3 and the air supply connection port 4b, and a link lever 15 as a sealing member provided with a valve sealing portion 15b that opens and closes the opening portion 4d. The link lever 15 is configured to take a sealing position that seals the opening portion 4d and a non-sealing position that opens the opening portion 4d in conjunction with the opening/closing operation of the toner container replacement door 2 as an opening/closing member. Specifically, the toner container replacement door 2 moves from a closed position that closes the mounting portion of the apparatus main body 100 to the outside to an open position that opens the mounting portion to the outside so as to allow attachment and detachment of the toner container 1, in conjunction with which the opening portion 4d is unsealed. That is, the toner container 1 is configured to be detachable from the apparatus main body 100 after the interior of the air conveyance passage 4 is communicated with the outside through the opening portion 4d.

The link arm 14 is an arm member that rotates around the door hinge 2a, which is the rotation center of the toner container replacement door 2. As shown in FIG. 8B, when the toner container replacement door 2 is opened, the tip portion of the link arm 14 engages with an engaging portion 15a of the link lever 15, moving the link lever 15 in the direction of the arrow. When the link lever 15 moves, the valve sealing portion 15b provided at the rear end portion of the link lever 15 moves away from the opening portion 4d, thereby releasing the air release valve 13. When the air release valve 13 is released, the air in the air conveyance passage 4 is released, and the air in the air chamber 1b of the toner container 1 connected to the air conveyance passage 4 is released.

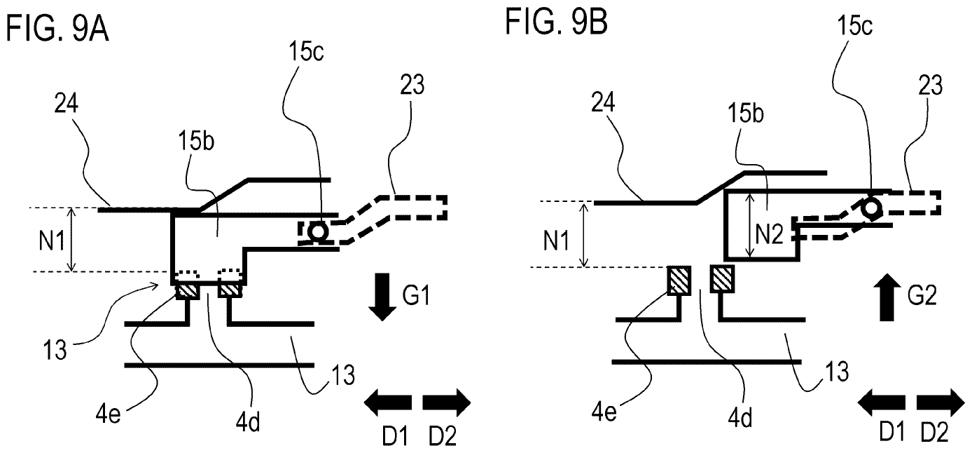

FIG. 9A and FIG. 9B are partial enlarged views illustrating the details of the sealing configuration of the air release valve 13. FIG. 9A shows a state in which the toner container replacement door 2 is closed and the air release valve 13 is in a sealed state (closed valve), and FIG. 9B shows a state in which the toner container replacement door 2 is opened and the air release valve 13 is in an unsealed state (open valve).

The image forming apparatus according to this embodiment includes a first guide portion 23 and a second guide portion 24 in the apparatus main body 100 as a guide mechanism for the link lever 15 to control the position of the valve sealing portion 15b of the link lever 15. The link lever 15 is provided with a guided portion 15c guided by the first guide portion 23.

In this embodiment, the link lever 15 is configured to be displaced in a direction substantially along the extending direction of the air conveyance passage 4 (in this embodiment, a direction along the attachment/detachment direction as the second direction of the toner container 1) by the opening/closing of the toner container replacement door 2. Accordingly, the direction in which the valve sealing portion 15b is displaced is also substantially parallel to the extending direction of the air conveyance passage 4. In contrast, the opening portion 4d is configured to open in a direction intersecting the extending direction of the air conveyance passage 4 (in this embodiment, a direction orthogonal to the extending direction and upward in the gravity direction). The first guide portion 23 and the second guide portion 24 guide the movement of the link lever 15 so as to displace the valve sealing portion 15b in the G1 and G2 directions intersecting the extending direction of the air conveyance passage 4 relative to the opening portion 4d without hindering the above displacement of the link lever 15. That is, the first guide portion 23 and the second guide portion 24 guide the movement of the link lever 15 so that the valve sealing portion 15b can be appropriately seated on and detached from the opening portion 4d.

In this embodiment, the first guide portion 23 is a groove-shaped guide portion recessed in a direction intersecting both the extending direction (D1, D2 directions) of the air conveyance passage 4 and the direction (G1, G2 directions) intersecting the extending direction of the air conveyance passage 4. The guided portion 15c is a protrusion-shaped (boss-shaped) guided portion protruding in a direction intersecting both the D1, D2 directions and the G1, G2 directions so as to fit into the first guide portion 23. The first guide portion 23 includes an inclined portion extending in a direction inclined with respect to the D1, D2 directions.

The first guide portion 23 guides the link lever 15 in a posture such that, in the D2 direction, when the valve sealing portion 15b is at a position farther from the opening portion 4d than the inclined portion, the valve sealing portion 15b is at a position (height) retracted from the opening portion 4d in the G2 direction. The first guide portion 23 guides the link lever 15 in a posture such that, in the D1 direction, when the valve sealing portion 15b is at a position closer to the opening portion 4d than the inclined portion, the valve sealing portion 15b is at a position (height) closer to the opening portion 4d in the G1 direction (second direction). The inclined portion of the first guide portion 23 is configured to be inclined to allow smooth displacement of the link lever 15 in the G1, G2 directions.

When the first guide portion 23 guides the link lever 15 to bring the valve sealing portion 15b closer to the opening portion 4d in the G1 direction, the second guide portion 24 also guides the link lever 15. The second guide portion 24 guides the valve sealing portion 15b in a direction approaching the opening portion 4d from behind in a manner that presses the head of the link lever 15 in the G1 direction. The opening portion 4d is provided with an elastic sealing member 4e that can seal to prevent air leakage from the opening portion 4d when the valve sealing portion 15b is connected.

The second guide portion 24 includes a flat surface portion parallel to the D1, D2 directions that contacts the valve sealing portion 15b in the G1 direction on the upper side when the valve sealing portion 15b and the opening portion 4d are connected. In the G1, G2 directions, the distance N1 between the flat surface portion of the second guide portion 24 and the elastic sealing member 4e is configured to be narrower than the width (height) N2 of the valve sealing portion 15b. Due to this dimensional relationship, it is possible to press the valve sealing portion 15b against the elastic sealing member 4e so that the elastic sealing member 4e is appropriately compressed in the G1 direction, enabling the sealed state of the air release valve 13 to be appropriately formed.

By operating the air release valve 13 in conjunction with the opening/closing operation of the toner container replacement door 2 to release air from the toner container 1 and then releasing the connection of the toner discharge portion 8, it is possible to prevent the toner T from blowing out from the toner discharge portion 8.

In this embodiment, a configuration in which the air release valve 13 is provided in the air conveyance passage 4 has been described, but it is not limited to this configuration. Similar to the toner container 1 shown in the second embodiment, the air release valve 13 may be provided in the toner container 1, and air release from the toner container 1 may be performed in conjunction with the opening/closing operation of the toner container replacement door 2 using a link configuration similar to this embodiment.

### Fourth Embodiment

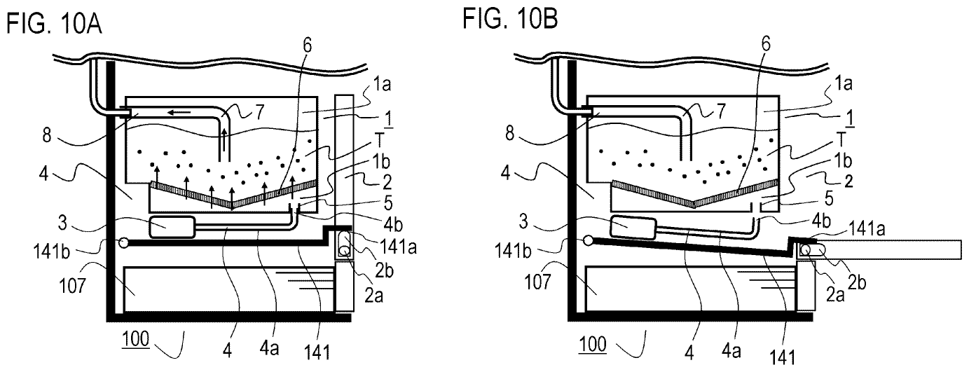

Referring to FIG. 10A and FIG. 10B, an image forming apparatus according to the fourth embodiment of the present disclosure will be described. In the fourth embodiment, a basic configuration of an apparatus main body 100, a toner container 1, and an outline of a configuration in which a toner T is conveyed from the toner container 1 to a toner accommodating portion of a developing device 104 by supplying air to the toner container 1 using a pump 3 are the same as those in the first embodiment. Here, a configuration different from those of the first to third embodiments in the fourth embodiment will be mainly described. In the fourth embodiment, matters not specifically described here are the same as those in the first to third embodiments.

FIG. 10A and FIG. 10B are cross-sectional views similar to the A-arrow view cross-section of the apparatus main body 100 in FIG. 1, showing a mechanism for air release. The air conveyance passage 4 includes an air conveyance tube 4a and an air supply connection port 4b. In this embodiment, the air supply portion 5 is provided on the bottom surface of the toner container 1, and the air supply connection port 4b is configured to be connected from below the toner container 1. The air release mechanism described in this embodiment is configured to open and close the flow passage in conjunction with the opening/closing operation of the toner container replacement door 2, and the details will be described below.

FIG. 10A shows a state in which the toner container replacement door 2 is closed, and FIG. 10B shows a state in which the toner container replacement door 2 is opened. In this embodiment, the pump 3 and the air conveyance passage 4 are held by a holding member 141. The toner container 1 is held by a member (not shown) separate from the holding member 141, and its vertical positioning is performed. The holding member 141 is configured such that one end 141a contacts a cam member 2b provided on the toner container replacement door 2, and it is rotatable about a fulcrum portion 141b provided at the other end.

The holding member 141 is configured such that the posture for holding the pump 3 and the air conveyance passage 4 changes due to the state of contact between the one end 141a and the cam member 2b changing according to the opening/closing of the toner container replacement door 2. Specifically, the holding member 141 is configured to take a connection posture in which the air supply connection port 4b of the air conveyance passage 4 and the air supply port 5a of the toner container 1 are connected, and a release posture in which the connection between the air supply connection port 4b and the air supply port 5a is released.

As shown in FIG. 10A, when the toner container replacement door 2 is closed, the holding member 141 is lifted upward on the one end 141a side by the cam member 2b provided on the toner container replacement door 2, resulting in a state in which the air supply connection port 4b and the air supply portion 5 are connected. Then, as shown in FIG. 10B, when the toner container replacement door 2 is opened, the change in phase of the cam member 2b provided on the toner container replacement door 2 causes the one end 141a side of the holding member 141 to move downward, thereby releasing the connection between the air supply connection port 4b and the air supply portion 5. Although a configuration in which the holding member 141 rotates is described here, a configuration in which the entire holding member 141 moves up and down in parallel may also be used. Additionally, although a configuration in which the air supply connection port 4b is inserted into the air supply portion 5 of the toner container 1 to be sealed is described here, a configuration in which sealing is achieved only by surface contact via a sealing member may also be used. In that case, since the engagement amount during sealing is small, the amount by which the holding member 141 retracts downward can be kept small, which is expected to suppress an increase in the size of the main body.

By providing a configuration that raises and lowers the holding member 141 in conjunction with the opening/closing operation of the toner container replacement door 2, it is possible to disconnect the toner discharge portion 8 after releasing air from the toner container 1, thereby preventing the toner T from blowing out from the toner discharge portion 8.

### Fifth Embodiment

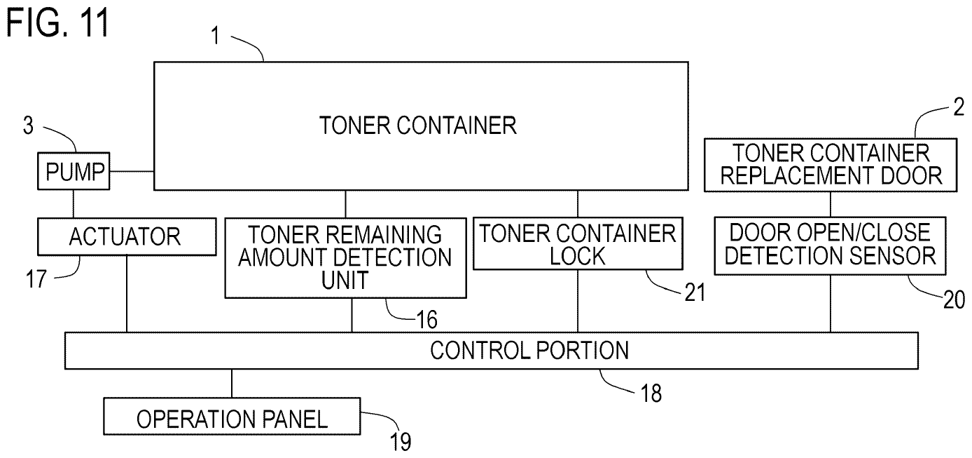

An image forming apparatus according to the fifth embodiment of the present disclosure will be described with reference to FIG. 11 to FIG. 13. In the fifth embodiment, a basic configuration of an apparatus main body 100, a toner container 1, and an outline of a configuration in which a toner T is conveyed from the toner container 1 to a toner accommodating portion of a developing device 104 by supplying air to the toner container 1 using a pump 3 are the same as those in the first embodiment. Here, configurations differing from the first to fourth embodiments in the fifth embodiment will be mainly described. Matters not specifically described here in the fifth embodiment are the same as in the first to fourth embodiments.

FIG. 11 is a block diagram showing the configuration of the control system of the toner supply portion in the fifth embodiment. The control portion 18 is configured to control each part of the image forming apparatus. The toner remaining amount detection unit 16 shown in FIG. 11 is a sensor (remaining amount sensor) that detects the remaining amount of toner T in the toner container 1. The toner remaining amount information detected by the toner remaining amount detection unit 16 is sent to the control portion 18. The pump 3 as the air supply portion is configured to perform a discharge operation that sends air to the air chamber 1b of the toner container 1 via the air conveyance passage 4 and a suction operation that sucks out (discharges) air from the air chamber 1b via the air conveyance passage 4. The actuator 17 is a conveying direction switching mechanism that acts on the pump 3 and can switch the air conveying direction to the toner container 1 between a supply direction and a discharge direction. The actuator 17 switches the air conveying direction of the pump 3 in response to instructions from the control portion 18. The door open/close detection sensor 20 is a sensor (open/close sensor) that detects the open/closed state of the toner container replacement door 2. The detection result from the door open/close detection sensor 20 is sent to the control portion 18. The toner container lock 21 is a locking unit (locking mechanism) for the toner container 1 that can move between a locked state in which the toner container 1 is fixed in the apparatus main body 100 and an unlocked state in which the toner container 1 can be removed, based on instructions from the control portion 18. That is, the toner container lock 21 can take a restricted state that restricts the toner container 1 from moving in the detachment direction from a predetermined position of the mounting portion of the apparatus main body 100 and a non-restricted state that allows the toner container 1 to move in the detachment direction from the predetermined position of the mounting portion.

As the pump 3, for example, a positive displacement pump such as a reciprocating pump or a rotary pump can be used. The reciprocating pump is a pump that performs suction and discharge by the reciprocating motion of a piston, plunger, or the like, and includes a piston pump, plunger pump, diaphragm pump, or the like. The rotary pump is a pump that performs suction and discharge by the rotational motion of gears, rotors, or the like, and includes a gear pump, screw pump, vane pump, or the like.

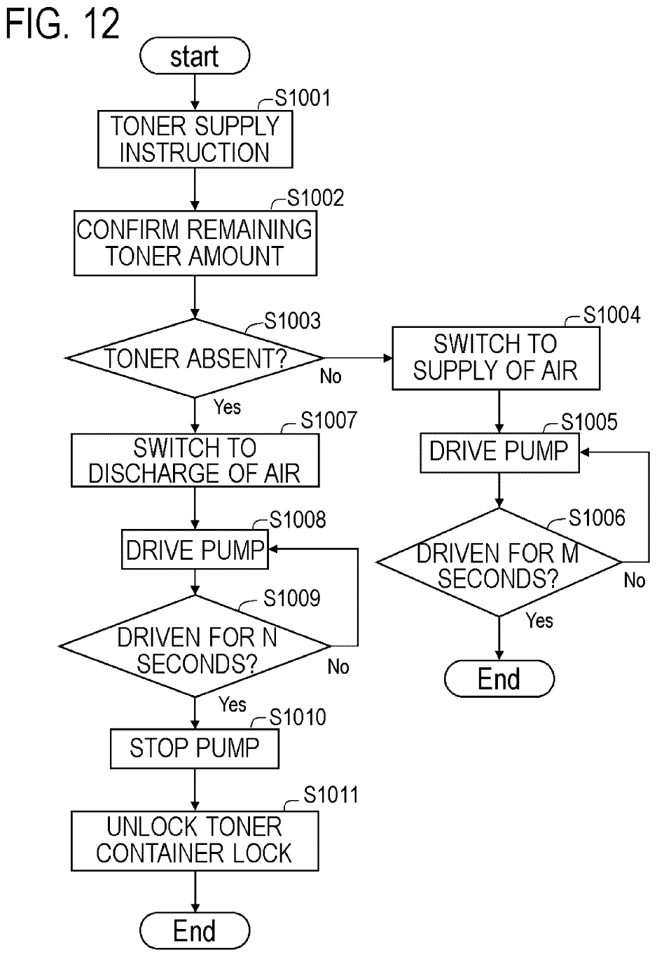

FIG. 12 is a flowchart showing the drive control of the actuator 17 that switches the air conveying direction of the pump 3 in this embodiment. When an instruction to supply toner T from the toner container 1 to the developing device 104 is issued (S1001), confirmation of the remaining toner amount in the toner container 1 is performed by the toner remaining amount detection unit 16 (S1002). The confirmation of the remaining toner amount by the toner remaining amount detection unit 16 may be determined, for example, by whether the detected remaining toner amount is equal to or less than a predetermined threshold amount. For example, if the remaining toner amount is greater than the predetermined amount, the remaining toner amount may be determined as “present,” and if the remaining toner amount is equal to or less than the predetermined amount, the remaining toner amount may be determined as “absent.”

If the toner T in the toner container 1 is detected as “present” (S1003: No), the air conveying direction of the actuator 17 is switched to the direction in which the pump 3 supplies air to the toner container 1 (S1004), and the pump 3 is driven to supply air to the toner container 1 (S1005). The pump 3 is driven for a predetermined time (M seconds) (S1006), and toner T is replenished.

If the toner T in the toner container 1 is detected as “absent” (S1003: Yes), the air conveying direction of the actuator 17 is switched to the direction in which the pump 3 discharges air from the toner container 1 (S1007). After the air conveying direction is switched, the pump 3 is driven for a predetermined time (N seconds) (S1008, S1009), and then the driving of the pump 3 is stopped (S1010). When the driving of the pump 3 is stopped, the toner container lock 21 is unlocked for replacing the empty toner container 1 (S1011).

By detecting that the toner container 1 is empty and discharging the air inside the toner container 1 at that point, the internal pressure of the toner container 1 becomes equivalent to the ambient atmospheric pressure. Since the toner container lock 21 is released after becoming equivalent to the atmospheric pressure, it is possible to prevent the remaining toner T from blowing out from the toner discharge portion 8 even if the connection of the toner discharge portion 8 is released thereafter.

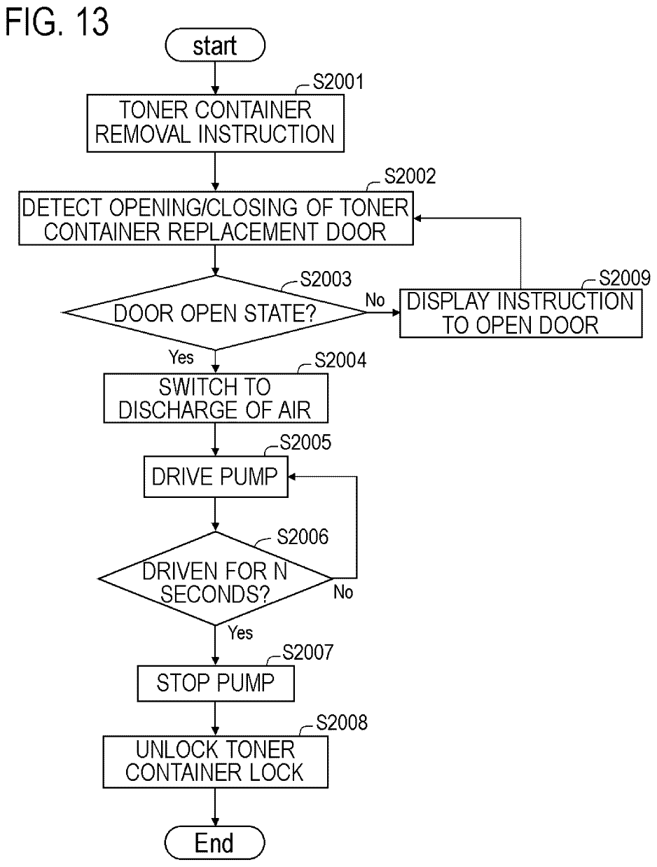

FIG. 13 is a flowchart showing the control when a user operates the operation panel 19 to remove a toner container 1 with sufficient toner T remaining. The operation panel 19 shown in FIG. 11 is an operation portion through which the user issues an instruction for removal of the toner container 1 from the apparatus main body 100. When an instruction to remove the toner container 1 is issued via the operation panel 19, a signal is sent to the control portion 18, and the control portion 18 starts the removal control of the toner container 1.

When the control portion 18 receives the removal instruction for the toner container 1 (S2001), the control portion 18 performs detection of the open/closed state of the toner container replacement door 2 using the door open/close detection sensor 20 that detects the open/closed state of the toner container replacement door 2 (S2002). Here, if the toner container replacement door 2 is detected as “closed” (S2003: No), an instruction to open the toner container replacement door 2 is displayed on the operation panel 19 for the user (S2009). If the toner container replacement door 2 is detected as “open” (S2003: Yes), the actuator 17 is driven, and the air conveying direction of the pump 3 is switched to the direction in which air is discharged from the toner container 1 (S2004). After the air conveying direction is switched, the pump 3 is driven for a predetermined time (N seconds) (S2005, S2006), and then the driving of the pump 3 is stopped (S2007). When the driving of the pump 3 is stopped, the toner container lock 21 is unlocked for replacing the toner container 1 (S2008).

By triggering the removal instruction of the toner container 1Y to discharge the air inside the toner container 1Y, it is possible to release air from the toner container 1Y, unlock the toner container lock 21, and then disconnect the toner discharge portion 8. This prevents the remaining toner T from blowing out from the toner discharge portion 8.

### Sixth Embodiment

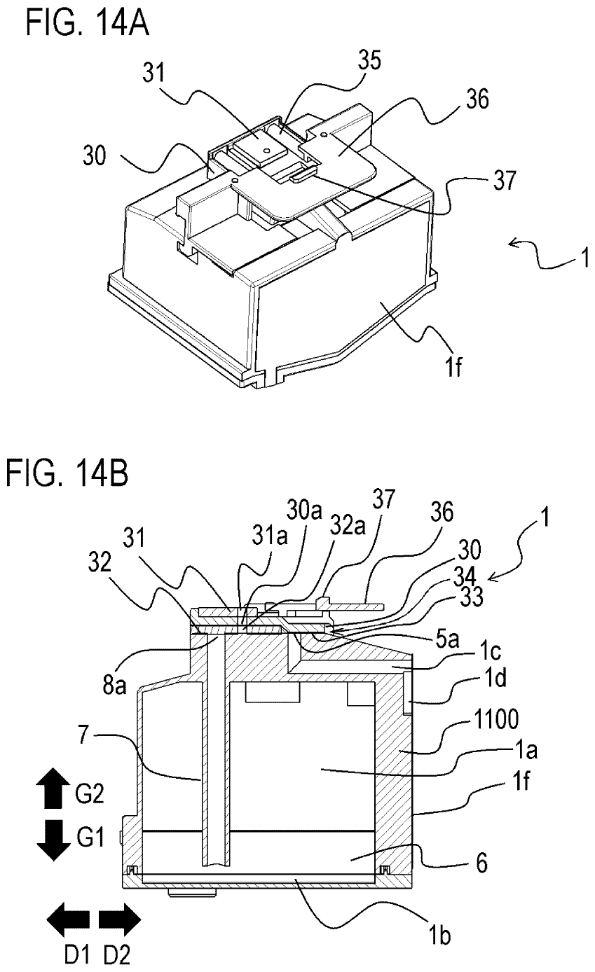

Referring to FIGS. 14A and 14B to FIGS. 18A to 18D, an image forming apparatus according to the sixth embodiment of the present disclosure will be described. The basic configuration of the apparatus main body 100, the toner container 1, and the outline of a configuration in which toner T is conveyed from the toner container 1 to the toner accommodating portion of the developing device 104 by supplying air to the toner container 1 using the pump 3 in the sixth embodiment are the same as in the first embodiment. Here, configurations differing from the first to fifth embodiments in the sixth embodiment will be mainly described. Matters not specifically described here in the sixth embodiment are the same as in the first to fifth embodiments.

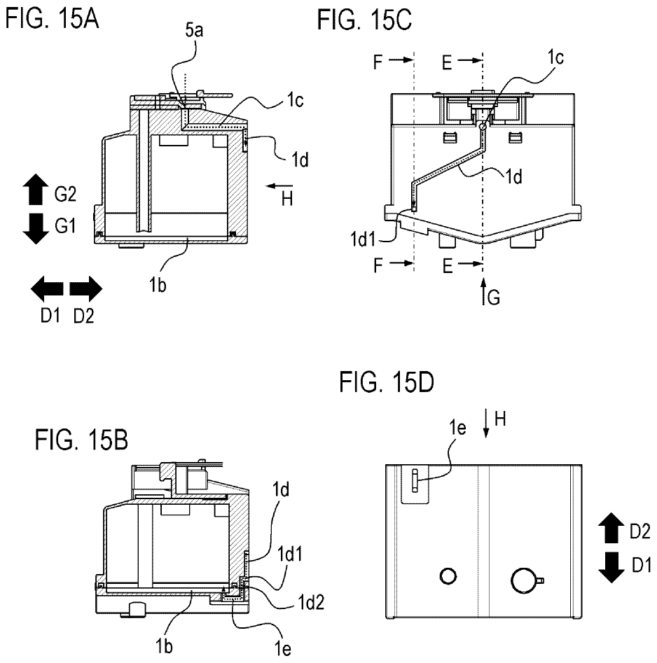

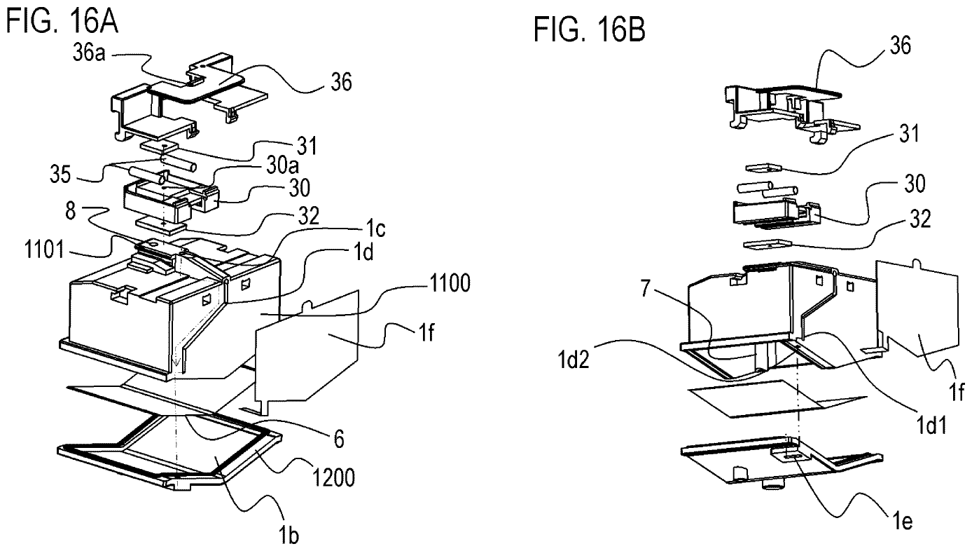

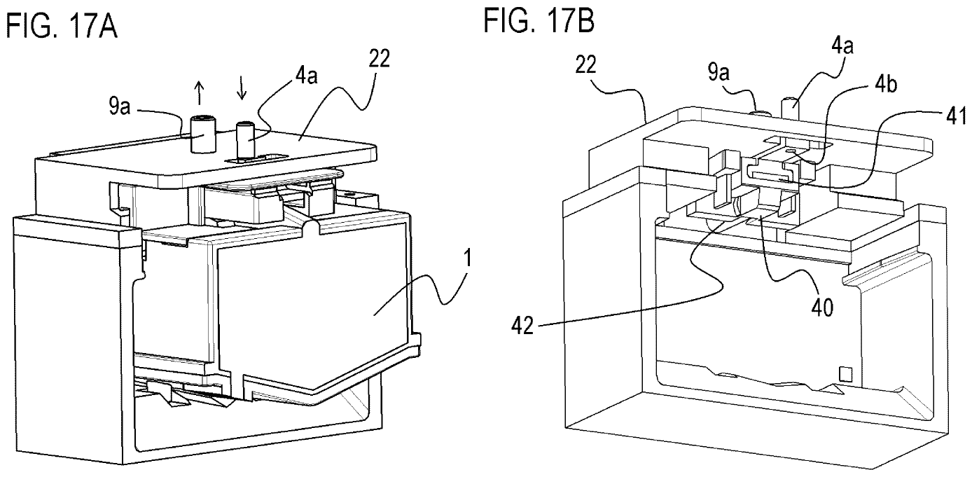

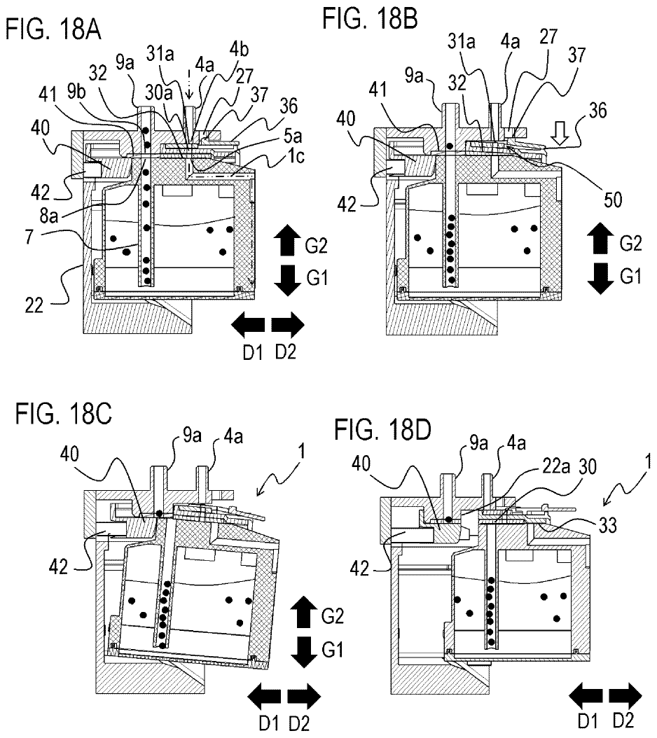

FIG. 14A is a perspective view of the toner container 1. FIG. 14B is a cross-sectional view of the toner container 1. FIG. 15A is a cross-sectional view of the toner container 1 without a label 1f attached, being a cross-section taken along the E-arrow in FIG. 15C. FIG. 15B is a cross-sectional view of the toner container 1 without a label 1f attached, being a cross-section taken along the F-arrow in FIG. 15C. FIG. 15C is a front view of the toner container 1 without a label 1f attached, being a view taken along the H-arrow in FIG. 15A. FIG. 15D is a bottom view of the toner container 1 without a label 1f attached, being a view taken along the G-arrow in FIG. 15C. FIG. 16A is an exploded view of the toner container 1, being an exploded perspective view shown at an angle looking diagonally downward from above the toner container 1. FIG. 16B is an exploded view of the toner container 1, being an exploded perspective view shown at an angle looking diagonally upward from below the toner container 1. FIG. 17A is a view showing a state in which the toner container 1 is mounted to the mounting portion 22. FIG. 17B is a view showing the mounting portion 22 with the toner container 1 removed. FIG. 18A to FIG. 18D are cross-sectional views illustrating the operation of a shutter 30 when the toner container 1 is removed from a state in which it is mounted to the mounting portion 22. FIG. 18A is a view showing a state in which the toner container 1 is mounted to the mounting portion 22 of the apparatus main body 100. FIG. 18B is a view showing a state in which a lever portion 36 as an operated portion is pressed down, and the engagement between the toner container 1 and the mounting portion 22 is released. FIG. 18C is a view showing a state in which the toner container 1 starts to be detached from a predetermined position of the mounting portion 22, and the shutter 30 starts moving from an open position to a closed position. FIG. 18D is a view showing a state in which the toner container 1 is detached from a predetermined position of the mounting portion 22, and the shutter 30 has completed moving to the closed position.

### Configuration of Toner Container

As shown in FIG. 16A and FIG. 16B, in this embodiment, the toner container 1 is configured such that the toner accommodating chamber 1a is formed by joining an upper container 1100 and a filter floor 6. Additionally, the air chamber 1b is formed by joining the filter floor 6 and a lower container 1200. The upper container 1100 is a frame constituting the toner container 1, primarily forming the toner accommodating chamber 1a. The lower container 1200 is a frame constituting the toner container 1, forming the air chamber 1b. The upper container 1100 is provided with a toner discharge passage 7 as a passage for discharging toner from the toner accommodating chamber 1a and a toner conveyance port 8a as an outlet of the toner discharge passage 7. The upper container 1100 and the lower container 1200 are provided with air flow passages 1c, 1d, and 1e for supplying air supplied from the apparatus main body 100 to the air chamber 1b, and an air supply port 5a as an inlet of the air flow passages 1c, 1d, and 1e is provided on the upper container 1100. The toner conveyance port 8a and the air supply port 5a are provided on an end surface of the upper container 1100 facing in an upward direction (G2 direction) among the vertical directions (G1, G2 directions) as a first direction intersecting the detachment direction (D1, D2 directions) of the toner container 1. Both the toner conveyance port 8a and the air supply port 5a open in the upward direction among the vertical directions (G1, G2 directions) as the first direction, that is, in the direction (G2 direction, third direction) from the air chamber 1b toward the toner accommodating chamber 1a.

The toner container 1 in this embodiment includes a shutter 30 that opens and closes the toner conveyance port 8a and the air supply port 5a. The shutter 30 is movably assembled on the end surface of the upper container 1100 where the toner conveyance port 8a and the air supply port 5a open. The moving direction of the shutter 30 is a direction along the attachment/detachment direction (D1, D2 directions) as a second direction of the toner container 1 with respect to a predetermined position of the mounting portion 22 (see FIGS. 17A and 17B and FIGS. 18A to 18D) of the apparatus main body 100. The toner conveyance port 8a and the air supply port 5a are aligned with each other in the attachment/detachment direction (D1, D2 directions) as the second direction, and the air supply port 5a is provided upstream of the toner conveyance port 8a in the attachment direction D1 among the attachment/detachment direction (D1, D2 directions) as the second direction. The shutter 30 is configured to be positioned at a closed position (non-communication position) that closes (blocks) both the toner conveyance port 8a and the air supply port 5a when the toner container 1 is not mounted to the mounting portion 22. The shutter 30 is configured to be positioned at an open position (communication position) that opens (does not block) both the toner conveyance port 8a and the air supply port 5a when the toner container 1 is mounted to a predetermined position of the mounting portion 22. When the shutter 30 is at the open position, the toner conveyance port 8a of the toner container 1 is connected to the toner conveyance connection port 9b of the apparatus main body 100 (mounting portion 22), and the air supply port 5a of the toner container 1 is connected to the air supply connection port 4b of the apparatus main body 100 (mounting portion 22).

The toner container 1 is configured to be positioned and held at a predetermined position in the mounting portion 22 by the engagement of an engaging portion 37 provided on the toner container 1 (shutter 30) with an engaged portion 27 provided on the mounting portion 22 when the toner container 1 is at the predetermined position in the mounting portion 22. The engaged portion 27 has a hole shape recessed in the upward direction (G2 direction, fourth direction) among the vertical directions (G1, G2 directions) as the first direction. The engaging portion 37 has a shape protruding in the upward direction (G2 direction, fourth direction) when the toner container 1 is mounted to the predetermined position of the mounting portion 22 and a predetermined operating force is not applied to a lever portion 36 described later, and is configured to fit into the engaged portion 27 in the same direction. FIG. 18A shows the posture (state) of the shutter 30 when the engaging portion 37 is at an engagement position where it engages with the engaged portion 27. By the engaging portion 37 fitting into the engaged portion 27, the engaging portion 37 and the engaged portion 27 are configured to be mutually engageable so as to restrict relative movement between the mounting portion 22 and the toner container 1 in the attachment/detachment direction (D1, D2 directions) as the second direction.

A lever portion 36 is provided on the shutter 30 as an operated portion for releasing the engagement between the engaging portion 37 and the engaged portion 27. The mounting portion 22 of the apparatus main body 100 has a box-like shape open in the detachment direction (D2 direction) among the attachment/detachment directions (D1, D2 directions) of the toner container 1 relative to the mounting portion 22. The lever portion 36 is provided on the shutter 30 to extend toward the detachment direction (D2 direction). The lever portion 36 is configured such that an upstream end portion in the detachment direction (D2 direction) is fixed to the shutter 30, and a downstream end portion (tip) is a free end. The side where the tip of the lever portion 36 is located is the side accessible to a user with respect to the toner container 1 mounted to the mounting portion 22. The lever portion 36 is configured to receive an operating force from the user acting in the downward direction (G1 direction) among the vertical directions (G1, G2 directions) at its tip side.

The shutter 30 has a sealing member (seal member) 32 as an elastic portion at a sliding portion with the end surface of the upper container 1100 where the toner conveyance port 8a and the air supply port 5a open in the toner container 1. The sealing member 32 is provided to seal the toner conveyance port 8a when the shutter 30 is at the closed position. The shutter 30 has an opposing portion 33 aligned upstream of the sealing member 32 in the attachment direction (D1 direction) and opposing the end surface of the upper container 1100 where the toner conveyance port 8a and the air supply port 5a open in the toner container 1. The opposing portion 33 is provided so as to face in the downward direction with respect to the air supply port 5a when the shutter 30 is in the closed position—that is, to oppose (cover the air supply port 5a) in the direction (G2 direction, fourth direction) from the air chamber 1b toward the toner accommodating chamber 1a. When the shutter 30 is at the open position, the sealing member 32 does not block the toner conveyance port 8a, and the opposing portion 33 retracts from a position opposing the air supply port 5a, resulting in a state where an air communication hole described later penetrating the shutter 30 in the vertical direction communicates with the air supply port 5a.

Additionally, the sealing member 32 is provided to allow elastic deformation (compressive deformation in the G1 direction) in the vertical direction between the shutter 30 and the end surface of the upper container 1100 when an operating force is applied to the lever portion 36 by the user while the shutter 30 is at the open position. The shutter 30 is configured such that, by the sealing member 32 as an elastic portion of the shutter 30 being compressed in the vertical direction, the shutter 30 can change to a posture in which the connection between the air supply port 5a of the toner container 1 and the air supply connection port 4b of the apparatus main body 100 (mounting portion 22) is released. Specifically, the downstream side (tip side) of the shutter 30 in the detachment direction (D2 direction) changes to a posture where it is displaced downward relative to the upstream side. As a result, in the shutter 30 the distance in the G2 direction (fourth direction) from the end surface of the upper container 1100 in at least a region of the shutter 30 including an air communication hole described later becomes shorter (the thickness of the shutter 30 in the G2 direction becomes smaller). Consequently, the air communication hole moves away from the air supply connection port 4b in the G1 direction (third direction), thereby releasing the connection between the air supply port 5a and the air supply connection port 4b. Additionally, this posture change is configured to release the engagement between the engaging portion 37 and the engaged portion 27. The engaging portion 37 is integrally provided with the lever portion 36, and the engagement with the engaged portion 27 is released as the lever portion 36 deforms by bending due to the operating force. That is, by applying an operating force to the lever portion 36 to release the engagement between the engaging portion 37 and the engaged portion 27, the toner container 1 can be detached from the mounting portion 22, but at that point, the connection between the air supply port 5a and the air supply connection port 4b is in a released state. FIG. 18B shows the posture (state) of the shutter 30 when the engaging portion 37 is at a release position where its engagement with the engaged portion 27 is released.

### Air Flow Passage of Toner Container

Referring to FIG. 15A to FIG. 15D, the configuration of the air flow passage of the toner container 1 in this embodiment will be described. The toner container 1 in this embodiment includes air flow passages 1c, 1d, and 1e as air flow passages connecting the air supply port 5a and the air chamber 1b. In FIG. 15A to FIG. 15C, the flow of air supplied from the apparatus main body 100 from the air supply port 5a to the air chamber 1b is indicated by dashed arrows.

As shown in FIG. 15A and FIG. 15B, the air flow passage 1c is formed by a hole provided in the upper container 1100. The air flow passage 1d is a flow passage connected downstream of the air flow passage 1c and is formed by a groove formed on the outer surface of the upper container 1100 and a label 1f attached to the outer surface of the upper container 1100 to cover the groove (see FIG. 14B). The air flow passage 1d, which is part of the air flow passages 1c, 1d, and 1e, is provided in a portion of the upper container 1100 upstream of the toner accommodating chamber 1a in the attachment direction D1. The label 1f is a sealing member attached to the upper container 1100 to seal the opening portion side of the groove provided on the front surface, which is the upstream end surface in the attachment direction (D1 direction) of the upper container 1100, and is a member that constitutes the air flow passage 1d together with the groove.

As shown in FIG. 15C, the air flow passage 1d includes air flow passage holes 1d1 and 1d2 forming a substantially L-shaped flow passage. The air flow passage hole 1d2 provided in the upper container 1100 is connected to the air flow passage 1e provided in the lower container 1200. The air flow passage 1e is formed by a groove formed on the outer surface of the lower container 1200 and a label 1f attached to the outer surface of the lower container 1200 to cover the groove (see FIG. 16A and FIG. 16B).

The air flow passages 1d and 1e are formed by holes or grooves formed from the upper container 1100 to the lower container 1200 and a label 1f (a resin sheet member) that does not allow air passage and is attached to the outer surfaces of the upper container 1100 and the lower container 1200 to cover such holes or grooves. Air flowing in from the air supply port 5a through the air flow passage 1c is supplied to the air chamber 1b via the air flow passages 1d and 1e.

In the toner container 1 in this embodiment, the label 1f is configured to be attached to the end surface of the toner container 1 in the detachment direction (D2 direction). The side of the toner container 1 where the label 1f is attached is the side accessible to the user with respect to the toner container 1. The label 1f may include various information about the toner container 1 (e.g., information regarding the color or type of toner).

### Shutter of Toner Container

The shutter 30 has a sealing member 32 attached to the side opposing the surface of the toner container 1 where the toner conveyance port 8a opens, for sealing the toner conveyance port 8a. Additionally, the shutter 30 has an air sealing member 31 (second elastic portion, second seal member) attached to the side opposite to the side where the sealing member 32 is attached in the vertical direction (the side opposing the lower end surface where the air supply connection port 4b of the mounting portion 22 opens). The sealing member 32 is provided with an air hole 32a, the shutter 30 is provided with a shutter hole 30a, and the air sealing member 31 is provided with an air sealing hole 31a. These air hole 32a, shutter hole 30a, and air sealing hole 31a communicate with each other to integrally form a single air communication hole penetrating the shutter 30 in the vertical direction.

The shutter 30 is slidably attached to a groove 1101 of the upper container 1100. The shutter 30 is biased by a shutter spring 35 as a biasing member in a direction to cover the toner conveyance port 8a. That is, the shutter spring 35 generates a biasing force between the shutter 30 and the upper container 1100 in a direction to move the shutter 30 from the open position (communication position) described above to the closed position (non-communication position). At this time, one end of the shutter spring 35, opposite to the side contacting the shutter 30, contacts a spring receiving portion 36a of the lever portion 36 attached to the upper container 1100.

The shutter 30 is positioned at the closed position by the biasing force of the shutter spring 35 when the toner container 1 is not mounted to the mounting portion 22 (FIG. 18D). When the toner container 1 is mounted to the mounting portion 22, the shutter 30 contacts an acting portion 22a provided on the mounting portion 22, and its movement in the attachment direction (D1 direction) is restricted to a predetermined position. As the toner container 1 is further pushed in the attachment direction (D1 direction) relative to the mounting portion 22 against the shutter 30 whose movement is restricted by contact with the acting portion 22a, the relative position between the shutter 30 and the toner container 1 changes in the attachment/detachment direction (D1, D2 directions). As a result, the shutter 30 moves from the closed position to the open position against the biasing force of the shutter spring 35 (FIG. 18A). When the shutter 30 is at the open position, the air sealing member 31 contacts the lower end surface (in the G1 direction) of the mounting portion 22 where the air supply connection port 4b opens, such that the air sealing hole 31a (air communication hole) is airtightly connected to the air supply connection port 4b.

Referring to FIG. 14B, the toner container 1 with the shutter 30 in the closed state will be described. The toner conveyance port 8a is covered by the sealing member 32, whereby toner can be prevented from leaking. At this time, the air communication hole (air sealing hole 31a, air hole 32a, shutter hole 30a) penetrating the shutter 30, the air sealing member 31, and the sealing member 32 is located at a position different from (not overlapping) the air flow passage 1c. Additionally, at this time, the sealing member 32 is at a position not opposing the air supply port 5a, and the air supply port 5a is covered by a part of the shutter 30. The opposing portion 33, which is the part of the shutter 30 covering the air supply port 5a, is configured to form a gap 34 with the top surface of the toner container 1 (upper container 1100) (the end surface where the air supply port 5a opens). The gap 34 is formed to communicate the air flow passage 1c with the outside of the toner container 1. By forming such a gap 34, the internal pressure of the toner container 1 does not increase even when the atmospheric pressure changes.

### Mounting Portion of Toner Container

Referring to FIG. 17A and FIG. 17B, the mounting portion 22 of the apparatus main body 100 to which the toner container 1 is mounted will be described. The air conveyance tube 4a is connected to the air supply connection port 4b. Additionally, the toner conveyance tube 9a is connected to the toner conveyance connection port 9b. The toner conveyance connection port 9b is covered by a toner shutter 40. The toner shutter 40 is biased in a direction to close the toner conveyance connection port 9b by a shutter spring 42 as a biasing member.

### Removal of Toner Container

Referring to FIG. 18A to FIG. 18D, the operation of the shutter 30 when the toner container 1 is removed from a state in which it is mounted to the mounting portion 22 of the apparatus main body 100 will be described.

First, referring to FIG. 18A, the state in which the toner container 1 is mounted to the mounting portion 22 of the apparatus main body 100 will be described. Air supplied from the pump 3 of the apparatus main body 100 is supplied to the air supply port 5a via the shutter hole 30a of the shutter 30, the air sealing hole 31a of the air sealing member 31, and the air hole 32a of the sealing member 32. The air is supplied to the air chamber 1b through the air flow passages 1d and 1e described previously. The supplied air is supplied to the toner accommodating chamber 1a through the filter floor 6. The toner is fluidized by the supplied air, discharged from the toner conveyance port 8a through the toner discharge passage 7, and supplied to the apparatus main body 100 via the toner conveyance connection port 9b.

Immediately after stopping the pump 3, toner remains in the toner conveyance passage, and the pressure in the toner accommodating chamber 1a and the air chamber 1b of the toner container 1 is high.

Next, referring to FIG. 18B, the operation during the removal of the toner container 1 will be described. The toner container 1 is configured to be mounted at a predetermined position (mounting posture) with respect to the mounting portion 22 by the engagement of the engaging portion 37, integrally provided with the lever portion 36, with the engaged portion 27 provided on the mounting portion 22 of the apparatus main body 100. When the lever portion 36 is pressed down, the sealing member 32 is compressed, causing the shutter 30 to be pressed down. The air sealing hole 31a of the air sealing member 31 of the shutter 30 moves away from the air supply connection port 4b of the mounting portion 22, creating a gap 50. The generation of this gap 50 releases the internal pressure inside the toner container 1. At this time, the toner that was lifted by the air falls due to its own weight, reducing the amount of toner near the toner conveyance port 8a of the toner container 1. In this way, by the attachment/detachment operation of the toner container 1, it is possible to first release the air supply port 5a, reduce the internal pressure in the toner container 1, and then release the toner conveyance port 8a.

Referring to FIG. 18C, the operation of further removing the toner container 1 will be described. As the toner container 1 is further pulled out, the acting portion 22a moves relatively away from the toner container 1, causing the shutter 30 to move from the open position to the closed position due to the biasing force of the shutter spring 35. As a result, the toner conveyance port 8a of the toner container 1 is gradually covered by the shutter 30. Simultaneously, the toner shutter 40 also moves from the open position to the closed position due to the biasing force of the shutter spring 42, and the toner conveyance connection port 9b of the mounting portion 22 of the apparatus main body 100 is gradually covered by the toner shutter 40.

The state in which the toner container 1 is further pulled out is shown in FIG. 18D. That is, the toner shutter 40 is fully closed in the apparatus main body 100 (mounting portion 22), and the shutter 30 is also fully closed in the toner container 1.

As described above, during the removal of the toner container 1 from the apparatus main body 100, the connection of the air supply passage is released first, and then the toner connection passage is released. Therefore, since the internal pressure of the toner container 1 is released before the toner connection passage is released, it is possible to prevent toner from blowing out from the toner container 1.

The configurations of the embodiments can be combined with each other as much as possible.

According to the present disclosure, it is possible to suppress contamination caused by the developer when detaching the developer container from the apparatus main body.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-216033, filed on Dec. 10, 2024, which is hereby incorporated by reference herein in its entirety.

What is claimed is:

1. A developer container, comprising:
a developer accommodating chamber that accommodates developer and is provided with a discharge port for discharging the accommodated developer to outside of the developer container;
a filter that allows passage of air and prevents passage of the developer; and
an air chamber partitioned from the developer accommodating chamber by the filter and provided with an air receiving port for receiving air, the air chamber being aligned with the developer accommodating chamber in a first direction,
wherein the discharge port and the air receiving port are both provided on an end surface of the developer container in a direction from the air chamber toward the developer accommodating chamber in the first direction.

2. The developer container according to claim 1,
wherein the discharge port and the air receiving port both open toward the first direction.

3. The developer container according to claim 2,
wherein the developer container is configured to be mountable by moving in an attachment direction in a second direction, which intersects the first direction, with respect to an apparatus main body of an image forming apparatus, and
wherein the air receiving port is provided on an upstream side of the discharge port in the attachment direction.

4. The developer container according to claim 1,
wherein the air receiving port is aligned with the discharge port in a second direction intersecting the first direction.

5. The developer container according to claim 1,
wherein an air flow passage communicating with the air receiving port and extending toward the air chamber is provided in a frame constituting the developer accommodating chamber.

6. The developer container according to claim 5,
wherein the developer container is configured to be mountable by moving in an attachment direction in a second direction, which intersects the first direction, with respect to an apparatus main body of an image forming apparatus, and
wherein the air receiving port is provided on an upstream side of the discharge port in the attachment direction, and
wherein at least a part of the air flow passage is provided in a part of the frame on an upstream side of the developer accommodating chamber in the attachment direction.

7. The developer container according to claim 6,
wherein a groove is provided in the frame, and
wherein the developer container has a sealing member attached to the frame to seal a side of an opening portion of the groove, the sealing member constituting the air flow passage together with the groove.

8. The developer container according to claim 7,
wherein the groove is provided on a front surface, which is an end surface on an upstream side in the attachment direction of the frame, and
wherein the sealing member is a label attached to the front surface, the label describing information about the developer container.

9. The developer container according to claim 1,
wherein the developer container comprises:
a shutter movable relative to the end surface between a closed position that closes both the discharge port and the air receiving port and an open position that opens both the discharge port and the air receiving port; and
a biasing member that applies a biasing force to the shutter in a direction of moving the shutter from the open position to the closed position.

10. The developer container according to claim 9,
wherein the developer container is configured to be mountable by moving in an attachment direction in a second direction, which intersects the first direction, with respect to an apparatus main body of an image forming apparatus, and
wherein a moving direction of the shutter relative to the end surface from the closed position to the open position is a direction toward an upstream side in the attachment direction in the second direction.

11. The developer container according to claim 10,
wherein the shutter comprises:
an elastic portion capable of elastic deformation, and sliding with the end surface;
an opposing portion aligned on a downstream side of the elastic portion in the attachment direction and opposing the end surface; and
an air communication hole penetrating the elastic portion in the first direction,
wherein the closed position is a position where the elastic portion closes the discharge port and the opposing portion opposes the air receiving port,
wherein the open position is a position where the elastic portion does not close the discharge port and the air communication hole communicates with the air receiving port,
wherein the first direction includes a third direction and a fourth direction, the third direction being, in the first direction, a direction from the developer accommodating chamber toward the air chamber, and the fourth direction being, in the first direction, a direction from the air chamber toward the developer accommodating chamber,
wherein the elastic portion is configured to be capable of compressive deformation in the third direction between the shutter and the end surface in a case where the shutter is at the open position, and
wherein the shutter, in a case of being at the open position, has a distance in the fourth direction from the end surface in at least a region including the air communication hole in the shutter by being reduced by the compression of the elastic portion in the third direction.

12. The developer container according to claim 11,
wherein in a case where the shutter is at the open position, the shutter is configured such that
in a state where the elastic portion is not compressed in the third direction, the shutter takes a first posture in which the air receiving port is connected to an air supply port of the apparatus main body via the air communication hole, and
by the elastic portion being compressed in the third direction, the shutter takes a second posture in which the air communication hole moves away from the air supply port in the third direction, thereby releasing the connection between the air receiving port and the air supply port.

13. The developer container according to claim 12,
wherein the shutter has a second elastic portion provided on an opposite side to the elastic portion in the first direction, the air communication hole penetrating therethrough in the first direction, and
wherein the second elastic portion contacts an end surface, where the air supply port opens in the third direction, of the apparatus main body, such that the air communication hole is airtightly connected to the air supply port in a case where the shutter is at the open position.

14. An image forming apparatus for forming an image on a recording material, the image forming apparatus comprising:
an apparatus main body having a main body accommodating portion that accommodates developer and a mounting portion; and
a developer container mounted, by being moved in an attachment direction, to the mounting portion, the developer container being configured to be detached by being moved in a detachment direction opposite to the attachment direction,
wherein the developer container comprises:
a developer accommodating chamber that accommodates developer and is provided with a discharge port for discharging the accommodated developer to outside of the developer container;
a filter that allows passage of air and prevents passage of the developer; and
an air chamber partitioned from the developer accommodating chamber by the filter and provided with an air receiving port for receiving air, the air chamber being aligned with the developer accommodating chamber in a first direction,
wherein the apparatus main body comprises:
a developer conveyance passage configured such that one end portion communicates with inside of the main body accommodating portion and another end portion is provided with a developer receiving port, the developer conveyance passage being configured such that the developer receiving port communicates with the discharge port of the developer container mounted at a predetermined position of the mounting portion;
an air supply passage provided with an air supply port, the air supply passage being configured to communicate with the air receiving port of the developer container mounted at the predetermined position of the mounting portion; and
an air supply portion that supplies air to the air chamber from the air receiving port of the developer container via the air supply passage, and
wherein the discharge port and the air receiving port are both provided on an end surface of the developer container in a direction from the air chamber toward the developer accommodating chamber in the first direction.

15. The image forming apparatus according to claim 14,
wherein the discharge port and the air receiving port both open toward the first direction.

16. The image forming apparatus according to claim 15,
wherein the first direction is a direction intersecting the attachment direction and the detachment direction, and
wherein the air receiving port is provided on an upstream side of the discharge port in the attachment direction.

17. The image forming apparatus according to claim 14,
wherein the air receiving port is aligned with the discharge port in the attachment direction.

18. The image forming apparatus according to claim 14,
wherein an air flow passage communicating with the air receiving port and extending toward the air chamber is provided in a frame constituting the developer accommodating chamber.

19. The image forming apparatus according to claim 18,
wherein the first direction is a direction intersecting the attachment direction and the detachment direction,
wherein the air receiving port is provided on an upstream side of the discharge port in the attachment direction, and
wherein at least a part of the air flow passage is provided in a part of the frame on an upstream side of the developer accommodating chamber in the attachment direction.

20. The image forming apparatus according to claim 18,
wherein a groove is provided in the frame, and
wherein the developer container has a sealing member attached to the frame to seal a side of an opening portion of the groove, the sealing member constituting the air flow passage together with the groove.

21. The image forming apparatus according to claim 20,
wherein the groove is provided on a front surface, which is an end surface on an upstream side in the attachment direction of the frame, and
wherein the sealing member is a label attached to the front surface, the label describing information about the developer container.

22. The image forming apparatus according to claim 14,
wherein the developer container comprises:
a shutter movable relative to the end surface between a closed position that closes both the discharge port and the air receiving port and an open position that opens both the discharge port and the air receiving port; and
a biasing member that applies a biasing force to the shutter in a direction of moving the shutter from the open position to the closed position.

23. The image forming apparatus according to claim 22,
wherein the first direction is a direction intersecting the attachment direction and the detachment direction, and
wherein a moving direction of the shutter relative to the end surface from the closed position to the open position is a direction toward the upstream side in the attachment direction.

24. The image forming apparatus according to claim 23,
wherein the shutter comprises:
an elastic portion capable of elastic deformation, and sliding with the end surface;
an opposing portion aligned on a downstream side of the elastic portion in the attachment direction and opposing the end surface; and
an air communication hole penetrating the elastic portion in the first direction,
wherein the closed position is a position where the elastic portion closes the discharge port and the opposing portion opposes the air receiving port,
wherein the open position is a position where the elastic portion does not close the discharge port and the air communication hole communicates with the air receiving port,
wherein the first direction includes a third direction and a fourth direction, the third direction being, in the first direction, a direction from the developer accommodating chamber toward the air chamber, and the fourth direction being, in the first direction, a direction from the air chamber toward the developer accommodating chamber,
wherein the elastic portion is configured to be capable of compressive deformation in the third direction between the shutter and the end surface in a case where the shutter is at the open position, and
wherein the shutter, in a case of being at the open position, has a distance in the fourth direction from the end surface in at least a region including the air communication hole in the shutter by being reduced by the compression of the elastic portion in the third direction.

25. The image forming apparatus according to claim 24,
wherein in a case where the shutter is at the open position, the shutter is configured such that
in a state where the elastic portion is not compressed in the third direction, the shutter takes a first posture in which the air receiving port is connected to an air supply port of the apparatus main body via the air communication hole, and
by the elastic portion being compressed in the third direction, the shutter takes a second posture in which the air communication hole moves away from the air supply port in the third direction, thereby releasing the connection between the air receiving port and the air supply port.

26. The image forming apparatus according to claim 25,
wherein the shutter has a second elastic portion provided on the opposite side of the elastic portion in the first direction, the air communication hole penetrating in the first direction, and
wherein the second elastic portion contacts an end surface, where the air supply port opens in the third direction, of the apparatus main body, such that the air communication hole is airtightly connected to the air supply port in a case where the shutter is at the open position.

27. The image forming apparatus according to claim 24,
wherein the discharge port and the air receiving port are provided on an end surface of the developer container in the fourth direction,
wherein the mounting portion has an engaged portion recessed in the fourth direction,
wherein the developer container has an engaging portion that engages with the engaged portion, the engaging portion being integrally provided to the shutter and protruding in the fourth direction in a state where the developer container is mounted at the predetermined position of the mounting portion,
wherein the engaging portion is configured to be movable, in a case where the shutter is at the open position, from an engagement position of engaging with the engaged portion to a release position of retracting in the third direction relative to the engaged portion to release the engagement with the engaged portion by the compression of the elastic portion in the third direction,
wherein the air receiving port is configured to be connected to the air supply port in a case where the engaging portion is at the engagement position and to have connection thereof with the air supply port released in a case where the engaging portion is at the release position, and
wherein the developer container is configured to be movable in the detachment direction from the predetermined position of the mounting portion in a case where the engaging portion is at the release position.

28. The image forming apparatus according to claim 14,
wherein the air chamber is located below the developer accommodating chamber in a state where the developer container is mounted at the predetermined position of the mounting portion.
